(19) United States
(12) Patent Application Publication
(10) Pub. No.: US 2011/0266708 A1
(43) Pub. Date: Nov. 3, 2011

(54) BLOW-INJECTION METHOD FOR PRODUCING PLASTIC FLOWER POT

(76) Inventor: Jun WANG, Jiangdu City (CN)

(21) Appl. No.: 13/018,563

(22) Filed: Feb. 1, 2011

(30) Foreign Application Priority Data
Apr. 30, 2010 (CN) 201010160065.4

(51) Int. Cl. B29C 49/46; B29C 49/64; B29C 49/00

(52) U.S. Cl. 264/85

(57) ABSTRACT

A blow-injection method for producing plastic flower pots comprising the following steps: fixing the fixed half, locking the moving half, injection, pressure maintaining, cooling, opening mould and ejection, wherein the gas pin is connected to the fixed half, and in pressure maintaining step, the nitrogen is blown in via the gas pin. The present invention integrate blow molding with injection molding, and is one-step formed, so the edge of the pots produced by the method of the invention is smooth and round, the edge of the pot is three-dimensional, Also, the center of the edge of the pot is hollow, the weight is reduced to enable cost-saving.

### FIELD OF THE INVENTION

The invention relates to a method for producing plastic articles.

### BACKGROUND OF THE INVENTION

Generally, the plastic flower pots are made by two ways: one is injection molding which has the following steps: fix the fixed half, lock the moving half, injection, pressure maintaining, cooling, opening mould and ejection, there is not too much request for the material in injection molding, for example, the recycled material can be reused by being mixed with new material, so the injection production can has low price, and the injection has high producing efficiency and low cost. The other way is blow, but the blow has high request for material, generally, the recycled material can not be reused, the blow has low efficiency, so the blow products have high price than the injection products.

The flower pots in market generally are made by injection molding, they can be used for replacing the traditional flower pot made of clay, glass, cement etc. and has advantages such as light, low price. But as the pot edge is the dividing line of the fixed half and the moving half in injection, the edge of the formed pot is not smooth enough, particularly, when the plant is put in the pot, because the earth is quite weight, so the edge is difficult to handle, and the material is thin, it is easy to be broken to affect the appearance and the use time of the lower pot.

### SUMMARY OF THE INVENTION

The primary object of the invention is to provide a blow-injection method for producing plastic flower pot which has smooth edge and is not easy to be broken.

The invention comprises the steps: fixing the fixed half, locking the moving half, injection, pressure maintaining, cooling, opening mould and ejection, wherein gas pin is connected to the fixed half, and in pressure maintaining step, the nitrogen is blow in via the gas pin.

After the injection step, the glue-like material with high temperature is flow into the mould cavity formed by the fixed half and moving half from the center of the fixed half, i.e. the glue-like material with high temperature is diffused from the bottom of the pot to the edge of the upper portion of the pot, then maintain pressure and blow nitrogen to the unformed edge of pot by the gas pin connected to the fixed half, by the air pressure, the glue-like material with high temperature unformed in the edge will be diffused around the mould, and then be cooled and formed.

The present invention integrate blow molding with injection molding, and is one-step formed, so the edge of the pot by the method of the invention is smooth and round, the edge of the pot is three-dimensional. Also, the center of the edge of the pot is hollow, the weight is reduced to enable cost-saving.

Preferredly, the blow condition is that: the nitrogen pressure blown in is between 220˜280 kg, the speed is between 200˜300 kg/s, and the time is between 40˜45 s.

Preferredly, in pressure maintaining step, the pressure in mould cavity is between 95˜125 kg, which can make desired formation and full plump for the edge.

### PREFERRED EMBODIMENT

### 1 Material Preparing

the recycled plastic material and new plastic material is mixed by the rate of 1:1, then the mixture is heat to 230˜300° C. and then is put into hopper.

### 2 Mould Preparing

Design out moving half and fixed half according to the sharp, size and thickness of the flower pot.

The centers of the moving half and fixed half are formed with water chamber respectively, and each chamber is connected with water inlet and water outlet.

The upper opening of the fixed half is inserted by a gas pin, and the out terminal of the gas pin is connected to nitrogen.

### 3/ Producing Process

a. the fixed half is fixed to the injection machine, cooling water is input into the water chamber of the fixed half via the water inlet and the water outlet.

b. the moving half is locked to the injection machine, cooling water is input into the water chamber of the moving half via the water inlet and the water outlet.

c. According to the sharp, size and thickness, the injection volume of each injection molding is automatically calculated by the electronic ruler of the injection machine, then press the switch of the injection machine to input the calculated injection volume from the hopper, and inject into the mould cavity by pump.

d. maintain the pressure of the mould cavity between 95˜125 kg, and open the nitrogen switch, the gas pin is inject with nitrogen of pressure 220˜280 kg, speed 200˜300 kg/s, and time 40˜45 s.

e. after cooled and formed, open the locking device of the moving half to separate the moving half.

f. the formed flower pot is ejected out from the fixed half.

g. The ejected flower pot can be further cooled in water.

What is claimed is:

1/ A blow-injection method for producing plastic flower pots comprising the following steps: fixing the fixed half, locking the moving half, injection, pressure maintaining, cooling, opening mould and ejection, wherein the gas pin is connected to the fixed half, and in pressure maintaining step, the nitrogen is blow in via the gas pin.

2/ The blow-injection method for producing plastic flower pots according to claim 1, wherein the nitrogen pressure blown in is between 220˜280 kg, the speed is between 200˜300 kg/s, and the time is between 40˜45 s.

3/ The blow-injection method for producing plastic flower pots according to claim 1, wherein in pressure maintaining step, the pressure in mould cavity is between 95˜125 kg.

4/ The blow-injection method for producing plastic flower pots according to claim 2, wherein in pressure maintaining step, the pressure in mould cavity is between 95˜125 kg.
